(19) United States
(12) Patent Application Publication
(10) Pub. No.: US 2026/0299602 A1
(43) Pub. Date: Oct. 1, 2026

(54) PATH PLANNING FOR DETERMINING ROUTES FOR CONTAINER HANDLING VEHICLES

(71) Applicant: AutoStore Technology AS, Nedre Vats (NO)

(72) Inventors: Vegard Syre-Aaker, Asker (NO); Torgeir Lilleskog, Aksdal (NO); Øystein Myrmo, Jar (NO); Torgeir Woldstad Skogen, Asker (NO)

(21) Appl. No.: 19/489,366

(22) PCT Filed: Jan. 22, 2024
(86) PCT No.: PCT/EP2024/051330

§ 371 Date: Dec. 2, 2025

(30) Foreign Application Priority Data
Jun. 15, 2023 (NO) 20230693

(51) Int. Cl. G05D 1/644; B65G 1/04; B65G 1/137; G05D 1/69; G05D 105/20; G05D 107/70; G05D 109/10

(52) U.S. Cl. CPC G05D 1/644; B65G 1/0464; B65G 1/1378; G05D 1/69; G05D 2105/20; G05D 2107/70; G05D 2109/14

(57) ABSTRACT

A method, system and computer program product of determining a route for a container handling vehicle (201, 301, 401) to a target area of a grid system such as a grid rail system (108). The method comprises determining the target area to be two or more connected grid cells (510), setting a task of moving a container handling vehicle to the target area (520), selecting a container handling vehicle to be moved to the target area (530), searching for and determining an optimal route for the selected container handling vehicle to the target area (540), instructing the selected container handling vehicle to move along the determined route to the target area (550).

### FIELD OF THE INVENTION

The present invention relates to an automated storage and retrieval system for storage and retrieval of storage containers, and in particular to a method, system and computer program product for planning and handling moving of a container handling vehicle operating on a grid system of the automated storage and retrieval system for preparing the container handling vehicle to handle a storage container.

### BACKGROUND

FIG. 1 discloses a prior art automated storage and retrieval system 10 with a framework structure 100 and FIGS. 2, 3 and 4 disclose three different prior art container handling vehicles 201,301,401 suitable for operating on such a system 10.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 10 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supporting.

Each prior art container handling vehicle 201,301,401 comprises a vehicle body 201a,301a,401a and first and second sets of wheels 201b, 201c, 301b, 301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 2010,301c,401c is arranged to engage with two adjacent rails of the second set 111 of rails. At least one of the sets of wheels 201b, 2010, 301b,301c,401b,401c can be lifted and lowered, so that the first set of wheels 201b,301b,401b and/or the second set of wheels 2010,301c,401c can be engaged with the respective set of rails 110, 111 at any one time.

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2 and is thus not shown.

Conventionally, and also for the purpose of this application, Z=1 identifies the uppermost layer available for storage containers below the rails 110,111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage grid cells. Each storage column may be identified by a position in an X- and Y-direction, while each storage grid cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a,401a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. U.S. Pat. No. 317,366, the contents of which are also incorporated herein by reference.

The cavity container handling vehicle 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

When a container handling vehicle 201, 301, 401 is requested to handle a storage container 106 at a specific grid cell, the exact destination or stop position of the vehicle body of the container handling vehicle 201, 301, 401 depends on the footprint of container handling vehicle 201, 301, 401 that is controlled. For a cavity container handling vehicle 201 shown in FIG. 2, the specific position of the grid cell will be the stop position of the vehicle body 201a. For a cantilever container handling vehicle 301 shown in FIG. 3, the stop position of the vehicle body 301a-will be any grid cell next to and overlapping with the specific grid cell such that the cantilever part that is handling a storage container 106 is directly above the specific grid cell.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail 110,111 may comprise two parallel tracks. In other rail systems 108, each rail in one direction (e.g. an X direction) may comprise one track and each rail in the other, perpendicular direction (e.g. a Y direction) may comprise two tracks. Each rail 110,111 may also comprise two track members that are fastened together, each track member providing one of a pair of tracks provided by each rail.

WO2018/146304A1, the contents of which are incorporated herein by reference, illustrates a typical configuration of rail system 108 comprising rails and parallel tracks in both X and Y directions.

In the framework structure 100, most of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. The transportation from the port to the access station may require movement along various directions, by means such as delivery vehicles, trolleys, or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301,401 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 10 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301,401 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 10, e.g. monitoring and controlling the location of respective storage containers 106 within the framework structure 100, the content of each storage container 106, and the movement of the container handling vehicles 201,301,401 so that a desired storage container 106 can be delivered to the desired location at the desired time without the container handling vehicles 201,301,401 colliding with each other, the automated storage and retrieval system 10 comprises a control system 121 which typically is computerized and which typically comprises a database for keeping track of the storage containers 106.

Jobs are assigned to container handling vehicles 201,301,401 for handling and transporting storage containers 106 from one location to another when operating on the rail system 108. When receiving an instruction to perform a job, a container handling vehicle 201,301,401 typically moves and follows a path from its current location to a destination for delivering or retrieving a storage container 106.

Path planning is a central part of software controlling the container handling vehicles to perform jobs. A path planning algorithm finding paths for robots, is the well-known A* search algorithm, finding a path for a robot to a destination.

In most situations, robots will have well-defined destinations. However, in some cases it is not important that a robot moves to a defined destination such as a specific grid cell, but rather to a specific area or towards a target grid cell. The reason for this may for instance be to position the robot close to an area on the grid where a job soon is expected to be requested.

An example of a case where a specific destination may not be defined is if a target destination is currently occupied but will be available at an unknown time in the future. Another example is if a robot currently does not have any valid job, such as handling a storage container 106. In this case, it would be smart to move the robot to an area where it is expected that a job will occur in near future. It may also be smart to distribute robots on the rail system 108 to have short distance to expected jobs. In both cases, it is not necessary to move the robot to an exact position.

The A* search algorithm and other similar algorithms do not address this since the algorithm works when a robot has a defined end goal, such as a defined target grid cell.

The present solution describes a method of determining a route and moving a container handling vehicle along the route to a target area of a grid system such as the grid rail system 108.

### SUMMARY OF THE INVENTION

This summary is provided to introduce in simplified form a selection of concepts that are further described herein. The summary is not intended to identify key or essential features of the invention.

The present invention is set forth and characterized in the independent claims, while the dependent claims describe other characteristics of the invention.

More specifically, and in a first aspect, the invention is defined by a method of determining a route for a container handling vehicle to a target area of a grid system, the grid system is arranged at least partially across a framework structure of an automated storage and retrieval system, a plurality of container handling vehicles are operable on the grid system to retrieve storage containers from, and deliver storage containers into storage columns arranged in rows between upright members of the framework structure, and to move the storage containers to and from one or more grid cells on the grid system corresponding to storage columns. The grid system may be a grid rail system.

The following steps are performed by a central control system which is in communication with a local controller of each container handling vehicle:
determining the target area to be two or more connected grid cells,
setting a task of moving a container handling vehicle to the target area,
selecting a container handling vehicle to be moved to the target area,
searching for and determining an optimal route for the selected container handling vehicle to the target area,
instructing the selected container handling vehicle to move along the determined route to the target area.

Connected grid cells are grid cells adjacent to each other, meaning that that the grid system arranged across the top of the framework structure run continuously from one grid cell to another.

According to one embodiment of the invention, the route determined is towards a target grid cell that is enclosed by the target area. The target area may for instance comprise grid cells within defined rectangles This target area may further be restricted to comprise grid cells from which move time from the grid cells within the rectangles to the target grid cell within the rectangle is less than a set time value.

According to one embodiment of the invention, the determined target area comprises grid cells within a set radius.

According to another embodiment of the invention, the determined target area of grid cells comprises grid cells within a set rectangle.

In one embodiment, the set radius defines a Manhattan distance from the container handling vehicle to the target grid cell.

In one embodiment, the grid cells of the target area comprise a list of preselected grid cells fully enclosing the target grid cell.

According to another embodiment of the invention, the determined target area of grid cells comprises grid cells from which move time from the grid cells to the target grid cell is less than a set time value, e.g. less that 4 s.

According to one embodiment, the determined target area of grid cells comprises grid cells within a first set radius and a second larger set radius.

According to one embodiment, the determined target area of grid cells comprises grid cells within a first set rectangle and a second larger set rectangle.

According to one embodiment, the target area of grid cells which is associated with the target grid cell further comprises grid cells from which move time or Manhattan distance from the grid cells to a target grid cell is less than a set time value

In a second aspect, the invention concerns a system of determining a route for a container handling vehicle to a target area of a grid system, the grid system is arranged at least partially across a framework structure of an automated storage and retrieval system, a plurality of container handling vehicles are operable on the grid system to retrieve storage containers from, and deliver storage containers into storage columns arranged in rows between upright members of the framework structure, and to move the storage containers to and from one or more grid cells on the grid system corresponding to storage columns, a central control system configured to communicate with a local controller of each container handling vehicle, wherein the central control system is configured to:
determine the target area to be two or more connected grid cells,
set a task of moving a container handling vehicle to the target area,
select a container handling vehicle to be moved to the target area,
search for and determine an optimal route for the selected container handling vehicle to the target area,
instruct the selected container handling vehicle to move along the determined route to the target area.

According to one embodiment, the system is configured to determine the route towards a target grid cell that is enclosed by the target area.

According to one embodiment, the system is configured to for determine the target area grid cells within a set radius.

According to another embodiment, the system is configured to determine the target area as grid cells within a set rectangle.

In one embodiment, the system is configured to set the radius by defining a Manhattan distance from the container handling vehicle to a target grid cell.

According to one embodiment, the system is configured to determine the target area of grid cells which is associated with the target grid cell to comprise grid cells from which move time or Manhattan distance from the grid cells to the target grid cell is less than a set time value.

In a third aspect, the invention is directed to computer program product for a central control system in the system of the second aspect, wherein the computer program product comprises instructions that when performed on the central control system performs the method according to the first aspect.

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view, seen from below, of a prior art container handling vehicle having an internally arranged cavity for carrying storage containers therein.

FIG. 5 is a schematic illustration of a target area within a predefined radius of a target grid cell X.

FIG. 6 is a schematic illustration of a target area providing a set move time to a target grid cell X.

FIG. 7a is a first schematic illustration of a target area defined by the location of grid cells surrounding a target grid cell X.

FIG. 7b is a second schematic illustration of a target area defined by the location of grid cells surrounding a target grid cell X.

FIG. 8 is a schematic illustration of a target area comprising predefined grid cells enclosing a target grid cell X.

FIG. 9 is a schematic illustration of a target area comprising predefined grid cells surrounding a target grid cell X within a first and second predefined radius of the target grid cell X.

FIG. 10 is a flowchart of a method according to the present invention for determining a route for a container handling vehicle to a target area of a grid system.

### DETAILED DESCRIPTION

In overview, a method of determining a route for a container handling vehicle to a target area of a grid system or grid rail system is provided. The method comprises determining the target area to be two or more connected grid cells, setting a task of moving a container handling vehicle to the target area, selecting a container handling vehicle to be moved to the target area, searching for and determining an optimal route for the selected container handling vehicle to the target area, instructing the selected container handling vehicle to move along the determined route to the target area.

In the following, embodiments of the invention will be discussed in more detail with reference to the appended drawings. It should be understood, however, that the drawings are not intended to limit the invention to the subject-matter depicted in the drawings.

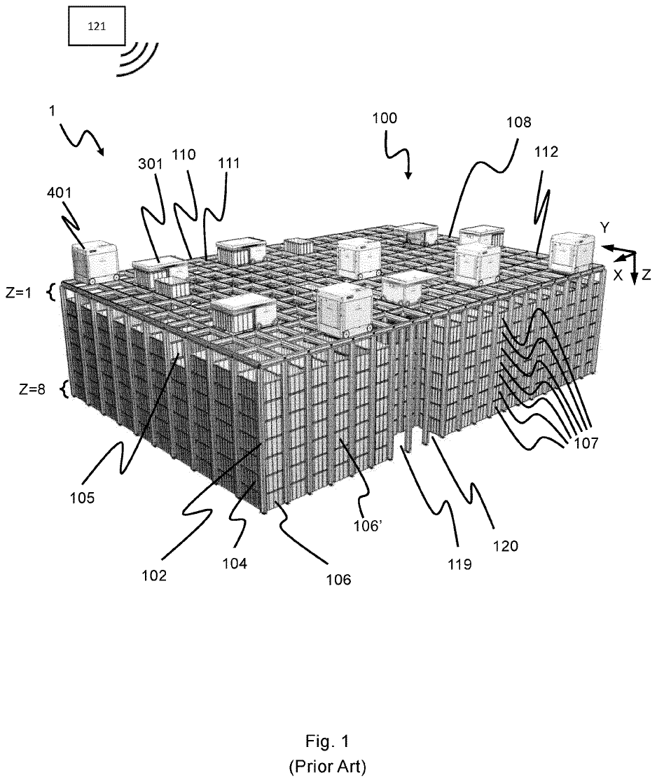

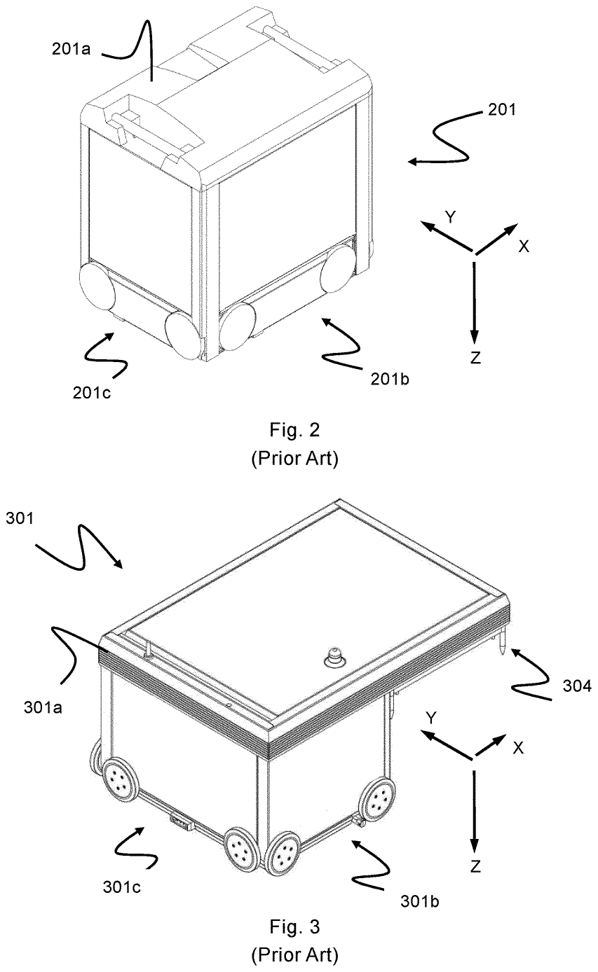

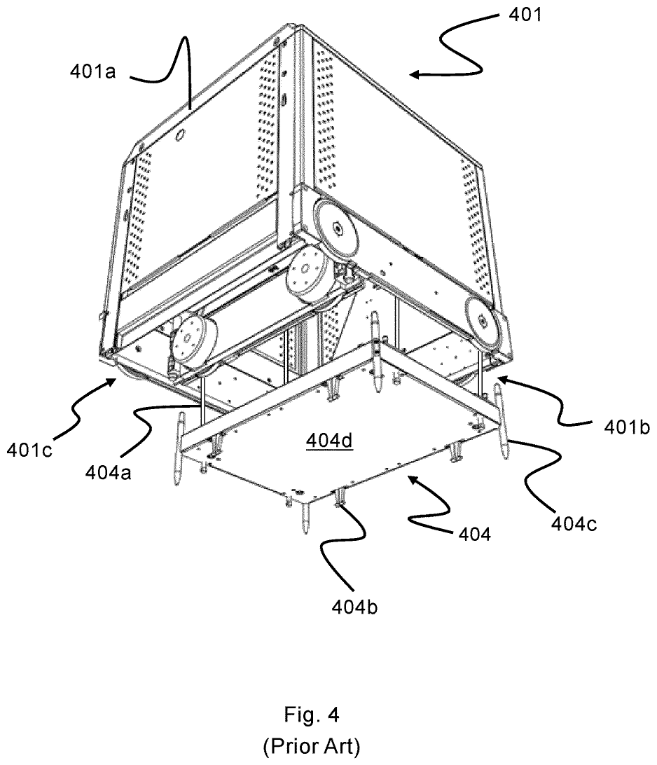

The framework structure 100 of the automated storage and retrieval system 10 is constructed in a similar manner to the prior art framework structure 100 described above in connection with FIG. 1. That is, the framework structure 100 comprises several upright members 102, and comprises a first, upper rail system 108 extending in the X direction and Y direction. Examples of container handling vehicles 201,301,401 running on the rail system 108 are illustrated in FIGS. 2-4.

The framework structure 100 further comprises storage compartments in the form of storage columns 105 provided between the members 102 wherein storage containers 106 are stackable in stacks 107 within the storage columns 105.

The framework structure 100 can be of any size. It is understood that the framework structure can be considerably wider and/or longer and/or deeper than disclosed in FIG. 1. For example, the framework structure 100 may have a horizontal extent of more than 700×700 columns and a storage depth of more than twelve containers.

As described in the background section above the present solution describes a method of determining a route and moving a container handling vehicle along the route to a target area of a grid rail system 108 without having defined target grid cell.

As mentioned, in a typical path planning algorithm, such as A*, the algorithm will terminate when a target grid cell is reached. However, according to the method described herein, the path planning algorithm may terminate whenever a container handling vehicle reaches a target area. When within the target area, the container handling vehicle may stop and wait for further instruction or continue to a target grid cell within the target area.

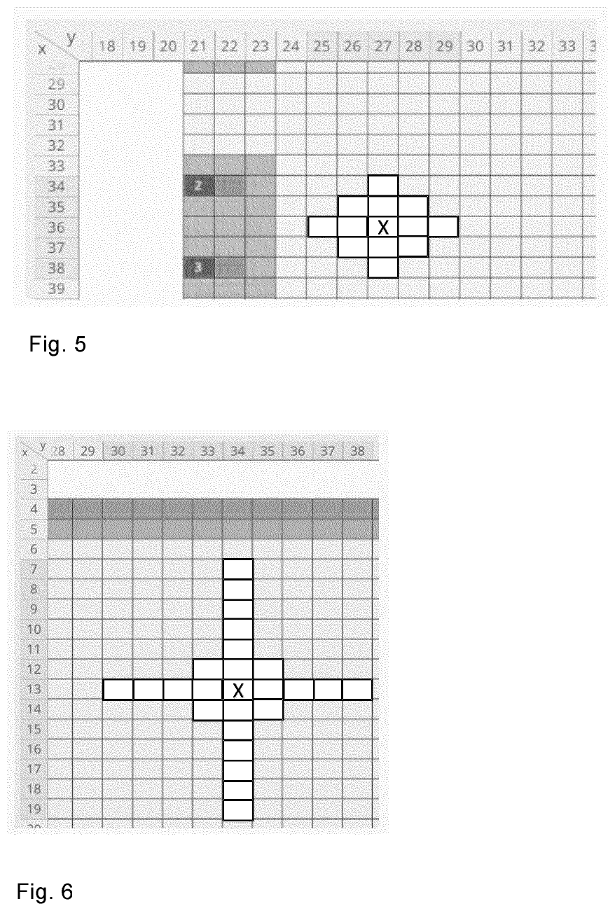

The method will now be explained by referring to several embodiments as illustrated in FIGS. 5-9. The figures illustrate a top view of different automated storage and retrieval systems 1 comprising grid cells. Grid rail systems 108 are arranged across framework structures 100 of the different automated storage and retrieval systems 1. Each grid cell has unique coordinates. In the figures, a target grid X is used for illustrative purposes. The solution will however also function by only defining a set of grid cells within a target area as defined in the independent claims.

FIG. 5 is a schematic illustration of a target area within a predefined set radius of a target grid cell marked with an X. The grid cells marked with 2 and 3 indicate ports for transferring storage containers 106. The set target area of grid cells associated with the target grid cell X comprises grid cells fully within the set radius of the target grid cell X as well as enclosing the target grid cell X. In the figure, the target area is set with a radius having an acceptance distance of 2, i.e. Manhattan distance. This means that a container handling vehicle will reach the target grid cell X having coordinates x=36 and y=27 from any direction by moving at most along 2 grid cells.

A container handling vehicle 201, 301, 401 receives a task from a central control system 121 which is in communication with a local controller of the container handling vehicle 201, 301, 401. The task determined by the central control system 121 may be to move along a route towards a target area of grid cells which is associated with the target grid cell X. In FIG. 5 this means any grid cell having a Manhattan distance of 2 from the target grid cell X at coordinates (36,27).

A route towards the target grid cell X is determined, e.g. by applying A* search algorithm. In some implementations, the A* search algorithm is applied to the target grid cell X to determine a route from the location of the container handling vehicle to the target grid cell X. The container handling vehicle then moves along the route. When moving along the route, position data of the container handling vehicle 201, 301, 401 is established, and the container handling vehicle 201, 301, 401 is instructed to stop and wait for further instructions or to continue to a target grid cell as planned once it is within the target area of grid cells. The container handling vehicle 201, 301, 401 will then be in a good position to perform a task at the target grid cell when instructed to do so.

In other implementations, a route is determined towards another grid cell in the target area, other than the target cell X. In this implementation, the target area is determined as above. Once the target area has been determined, an algorithm is used to determine a route to a grid cell in the target area.

The route is determined as follows. The system determines which grid cell, of the plurality of grid cells in the target area, is closest to the selected container handling vehicle. Once the closest cell is determined, the A* algorithm is used to determine the first cell on the route. This is done by determining the best first cell on a route towards the identified closest cell. This is done by considering each of the available cells. Once the first cell on the route (the first route cell) is determined, the system then finds the closest cell in the target area to the first route cell. That is, the system determines which grid cell, of the plurality of grid cells in the target area, is closest to the first route cell. This is the updated closest cell. Once the updated closest cell is determined, the A* algorithm is used to determine the next cell on the route. This is done by determining the best next cell on a route towards the updated closest cell. This next cell is the second route cell. The process is then repeated from the second route cell: the closest cell in the target area to the second route cell is determined (updated closest cell), and an algorithm is used to find the best next cell on the route to reach the updated closest cell. This process is repeated until it is determined that the closest cell in the target area to the n^{th} route cell is the n^{th} route cell, indicating that the route has reached the grid area.

There is disclosed a method for determining a route to a grid cell in the target area. For each cell on the route (‘route cell’), the system calculates an updated closest cell in the target area, and determines the next route cell by determining next cell on a route towards the updated closest cell. The process repeats for each route cell until the route reaches the target area.

FIG. 6 is a schematic illustration of another embodiment showing a target area providing a set move time to a target grid cell X. In this embodiment, the target area comprises grid cells providing least move time to a target grid cell X. This is like Manhattan distance, except that the radius would be the time around the target grid cell X. This option would minimize/define the time from the outer radius to the target grid cell X. The figure shows the least move time with radius of ~4 seconds from the target grid cell X.

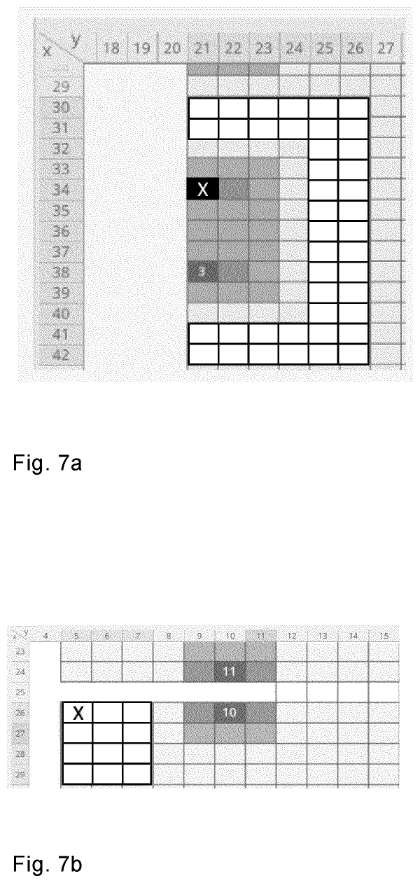

FIG. 7a is a first schematic illustration of a target area defined by the location of grid cells surrounding a target grid cell X. The target may be a port which in this example is located at coordinates (34, 21).

Using the location of grid cells surrounding a target grid cell X may be used if the grid layout is complex. FIG. 7b is an example of this, showing a second schematic illustration of a target area defined by the location of grid cells comprising a target grid cell X. Here, the target grid cell X is close to an edge. A distance radius or move time radius, as illustrated in FIGS. 5 and 6, could accept destinations on the other side of the blocked cells which is not feasible.

Ta address this problem, a combination of least move time radius and Manhattan distance, ref. FIGS. 5 and 6, and grid cells at defined locations, ref. FIGS. 7a and 7b, is another. In this scenario, a target area would need to be both within the radius and at one of grid cells at defined locations to be valid. The grid cells that are covered by both the radius and grid cells at defined location of should fully surround the target. In this embodiment, the radius defines how close to a target grid cell the A* search algorithm should terminate, and the grid cells at defined locations defines oddities on the grid and grid cells that should be avoided.

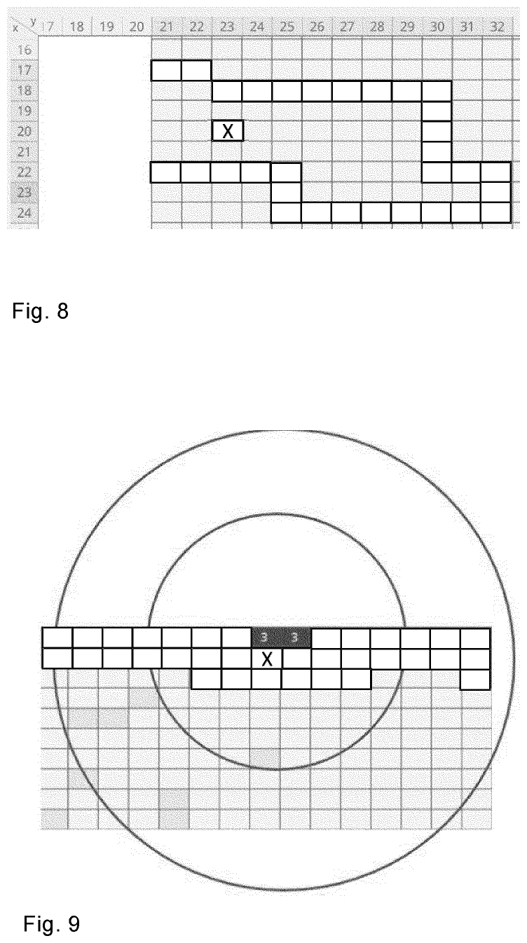

FIG. 8 is a schematic illustration of a target area comprising predefined grid cells enclosing a target grid cell X. In this embodiment, any of the predefined grid cells will be the target area where a container handling vehicle 201, 301, 401 will stop or respond to further instructions from the central control system 121 for performing a job at target grid cell X.

FIG. 9 is a schematic illustration of a target area comprising predefined grid cells surrounding target grid cell X within a first predefined radius and second larger predefined radius of the target grid cell X. This embodiment addresses scenarios where a container handling vehicle 201, 301, 401 must move from a current stop position leaving the target area within the first predefined radius, for instance to let another container handling vehicle 201, 301, 401 pass. In most cases this would be unproblematic, as the container handling vehicle 201, 301, 401 would be close enough to a target grid cell. However, if it should propose a problem, the solution is to define a second larger radius from the target grid cell X which is used as a hysteresis. If the robot is located within the second radius at the start of a path planning algorithm, the path planning algorithm can still use the target grid cell as a destination without moving the robot into the first radius.

It is a prerequisite that the shape/grid cells/radius chosen to fully enclose or surround a target grid cell. If not, it would be possible for the A* search algorithm to find a path to the target without visiting any of the grid cells around.

For controlling a container handling vehicle 201, 301, 401, different commands are transmitted from the central control system 121 such as PUT, GET and MOVE. For placing a storage container 106 in a dedicated drop-off port column, for instance a port, the PUT command is used. For retrieving a storage container 106 from a pick-up column, the GET command is used. For moving a container handling vehicle 201,301,401 to a target grid cell, the MOVE command is used.

The different embodiments of the method described above may be used in a scenario where a container handling vehicle 201,301,401 received a PUT or GET command but cannot reach a target within a time limit. The command can then be converted to a MOVE command, i.e. move to a target area. The container handling vehicle 201,301,401 will then be close to a drop-off or pick-up column where a job is soon expected to be requested.

A target grid cell may not necessarily be one specific grid cell. According to one embodiment, the target grid cell is any grid cell within a set target area that is closest to current position of the selected container handling vehicle. This will then be the target grid cell for the A* search algorithm.

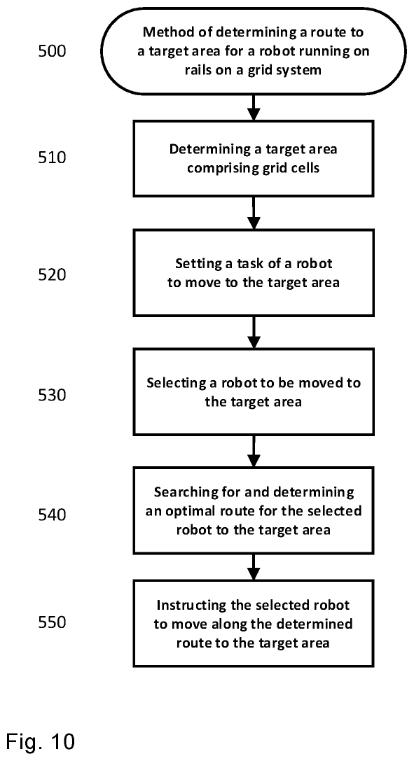

FIG. 10 is a flowchart of a method according to the present invention of determining a route 500 for a container handling vehicle 201, 301, 401 to a target area of a grid rail system 108 comprising grid cells.

Steps 510, 520, 530 shown in the figure can be performed in any order. Typically, the first step of the method is to set determine a target area 510 comprising two or more grid cells. The grid cells within a target area may for instance be a set of twelve grid cell enclosing a target grid cell.

The next step 520 is setting a task of a robot to move to the target area. The target area may typically comprise grid cells enclosing a port where a storage container 106 is placed or retrieved. The destination for a search algorithm may be any grid cell within the target area that currently is closest to the position of the container handling vehicle 201, 301, 401, or it may be a specific target grid cell within the target area, e.g. a port.

The next step 530 is to select a container handling vehicle 201, 301, 401 to move to the target area.

In step 540, an optimal route for the container handling vehicle 201, 301, 401 to the target area, or target grid cell within the target area, is searched for and determined.

The selected container handling vehicle 201, 301, 401 is instructed to move along the determined route 550 to the target area. Due to traffic of other container handling vehicles 201, 301, 401, the optimal route for the selected container handling vehicle 201, 301, 401 is typically changed several times before reaching a target area.

The present solution allows more flexible target destinations and routing to areas of the grid system having high activity and where for instance jobs are expected to be requested. By positioning container handling vehicles close to areas on the grid system where jobs are expected to be requested, fewer conflicts between routes for several container handling vehicles are expected, which in turn will give more optimal routes since the container handling vehicles need to travel less distance to do a job. Another advantage of the described solution is low computational overhead compared to the standard A* search algorithm.

### LIST OF PRIOR ART REFERENCE NUMBERS (FIGS. 1-4)

| | |
|---|---|
| 10 | Prior art automated storage and retrieval system |
| 100 | Framework structure |
| 102 | Upright members of framework structure |
| 104 | Storage grid |
| 105 | Storage column |
| 106 | Storage container |
| 106′ | Particular position of storage container |
| 107 | Stack |
| 108 | Rail system |
| 110 | Parallel rails in first direction (X) |
| 112 | Access opening |
| 119 | First port column |
| 120 | Second port column |
| 201 | Prior art container handling vehicle |
| 201a | Vehicle body of the container handling vehicle 201 |
| 201b | Drive means/wheel arrangement/first set of wheels in |
| | first direction (X) |
| 201c | Drive means/wheel arrangement/second set of wheels in |
| | second direction (Y) |
| 301 | Prior art cantilever container handling vehicle |
| 301a | Vehicle body of the container handling vehicle 301 |
| 301b | Drive means/first set of wheels in first direction (X) |
| 301c | Drive means/second set of wheels in second direction (Y) |
| 304 | Gripping device |
| 401 | Prior art container handling vehicle |
| 401a | Vehicle body of the container handling vehicle 401 |
| 401b | Drive means/first set of wheels in first direction (X) |
| 401c | Drive means/second set of wheels in second direction (Y) |
| 404 | Gripping device |
| 404a | Lifting band |
| 404b | Gripper |
| 404c | Guide pin |
| 404d | Lifting frame |
| 121 | Control system |
| X | First direction |
| Y | Second direction |
| Z | Third direction |

1.-22. (canceled)

23. A method of determining a route for a container handling vehicle to a target area of a grid system, the grid system is arranged at least partially across a framework structure of an automated storage and retrieval system, a plurality of container handling vehicles are operable on the grid system to retrieve storage containers from, and deliver storage containers into storage columns arranged in rows between upright members of the framework structure, and to move the storage containers to and from one or more grid cells on the grid system corresponding to storage columns, wherein the following steps are performed by a central control system which is in communication with a local controller of each container handling vehicle:
determining the target area to be two or more connected grid cells;
setting a task of moving a container handling vehicle to the target area;
selecting a container handling vehicle to be moved to the target area;
searching for and determining an optimal route for the selected container handling vehicle to the target area; and
instructing the selected container handling vehicle to move along the determined route to the target area.

24. The method of claim 23, wherein the grid system is a grid rail system.

25. The method of claim 23, wherein the route determined is towards a target grid cell that is enclosed by the target area, and optionally wherein the determined target area of grid cells comprises grid cells from which move time from the grid cells to the target grid cell is less than a set time value or wherein the target area of grid cells further comprises grid cells from which move time or Manhattan distance from the grid cells to the target grid cell is less than a set time value.

26. The method of claim 23, wherein determining an optimal route for the selected container handling vehicle to the target area comprises:
calculating which grid cell, of the plurality of grid cells in the target area, is closest to the starting cell of the selected container handling vehicle;
determining the next cell on the optimal route by determining the next cell on a route towards the identified closest cell; and
for each subsequent cell on the optimal route:
calculating an updated closest grid cell in the target area; and
determining the next cell on the optimal route by determining the next cell on a route towards the updated closest cell.

27. The method of any claim 23, wherein the determined target area of grid cells comprises grid cells within a set radius.

28. The method of claim 23, wherein the determined target area of grid cells comprises grid cells within a set rectangle.

29. The method of claim 27, wherein the set radius defines a Manhattan distance from the container handling vehicle to a target grid cell.

30. The method of any claim 23, wherein the grid cells comprise a list of preselected connected grid cells.

31. The method of claim 23, wherein the determined target area of grid cells comprises grid cells within a first set radius and a second larger set radius.

32. The method of claim 23, wherein the determined target area of grid cells comprises grid cells within a first set rectangle and a second larger set rectangle.

33. A system of determining a route for a container handling vehicle to a target area of a grid system, the rail system is arranged at least partially across a framework structure of an automated storage and retrieval system, a plurality of container handling vehicles are operable on the grid system to retrieve storage containers from, and deliver storage containers into storage columns arranged in rows between upright members of the framework structure, and to move the storage containers to and from one or more grid cells on the grid system corresponding to storage columns, a central control system configured to communicate with a local controller of each container handling vehicle, wherein the central control system is configured to:
determine the target area to be two or more connected grid cells,
set a task of moving a container handling vehicle to the target area,
select a container handling vehicle to be moved to the target area,
search for and determine an optimal route for the selected container handling vehicle to the target area, and
instruct the selected container handling vehicle to move along the determined route to the target area.

34. The system of claim 33, wherein the grid system is a grid rail system.

35. The system of claim 33, wherein the central control system is configured to determine the route towards a target grid cell that is enclosed by the target area.

36. The system of claim 33, wherein the central control system is configured to determine an optimal route for the selected container handling vehicle to the target area by:
calculating which grid cell, of the plurality of grid cells in the target area, is closest to the starting cell of the selected container handling vehicle;
determining the next cell on the optimal route by determining the next cell on a route towards the identified closest cell; and
for each subsequent cell on the optimal route:
calculating an updated closest grid cell in the target area; and
determining the next cell on the optimal route by determining the next cell on a route towards the updated closest cell.

37. The system of claim 33, wherein the central control system is configured to determine the optimal route from the selected container handling vehicle towards the closest grid cell in the grid area.

38. The system of claim 33, wherein the central control system is configured to determine the target as grid cells within a set radius.

39. The system of claim 33, wherein the central control system is configured to determine the target area as grid cells within a set rectangle.

40. The system of claim 37, wherein the central control system is configured to set the radius by defining a Manhattan distance from the container handling vehicle to a target grid cell.

41. The system according to claim 35, wherein the central control system is configured to determine the target area of grid cells which is associated with the target grid cell to be grid cells from which move time or Manhattan distance from the grid cells to the target grid cell is less than a set time value.

42. A computer program product for a central control system of a system of determining a route for a container handling vehicle to a target area of a grid system, wherein the rail system is arranged at least partially across a framework structure of an automated storage and retrieval system, a plurality of container handling vehicles are operable on the grid system to retrieve storage containers from, and deliver storage containers into storage columns arranged in rows between upright members of the framework structure, and to move the storage containers to and from one or more grid cells on the grid system corresponding to storage columns, and wherein the central control system is configured to communicate with a local controller of each container handling vehicle, wherein the computer program product comprises instructions that, when performed on the central control system, perform:
determining the target area to be two or more connected grid cells;
setting a task of moving a container handling vehicle to the target area;
selecting a container handling vehicle to be moved to the target area;
searching for and determining an optimal route for the selected container handling vehicle to the target area; and
instructing the selected container handling vehicle to move along the determined route to the target area.
